(19) United States
(12) Patent Application Publication
(10) Pub. No.: US 2005/0260895 A1
(43) Pub. Date: Nov. 24, 2005

(54) Holding device

(75) Inventor: Tomoaki Aoshima, Hamamatsu-shi (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignee: NIFCO INC., Yokohama (JP)

(21) Appl. No.: 11/129,289

(22) Filed: May 16, 2005

(30) Foreign Application Priority Data
May 24, 2004 (JP) 2004-152946

(51) Int. Cl. H01R 13/514

(52) U.S. Cl. 439/752

(57) ABSTRACT

A holding device made of resin is integrally provided with an attaching portion having a plurality of elastic engaging pieces on an inner surface of an insertion hole, and at least one holding portion disposed on one side or both sides of the attaching portion for holding an article. A stud with a circumferential groove protrudes from a panel. The stud is inserted into the insertion hole while the engaging pieces deform elastically and engage the circumferential groove of the stud. The engaging pieces are oppositely formed on the internal surface of the insertion hole at front and rear sides shifted by 90 degrees from the sides adjacent to the holding portions. The engaging pieces are arranged in more than two levels in an axial direction of the insertion hole.

### BACKGROUND OF THE INVENTION AND RELATED ART STATEMENT

The present invention relates to a holding device having a holding portion for holding an article and an attaching portion to be fixed to a stud protruding from a panel.

FIGS. 13(a) and 13(b) are views showing a holding device disclosed in Patent Reference 1, wherein FIG. 13(a) is a front view thereof without side portions, and FIG. 13(b) is a sectional view of an attaching portion fixed to a stud. A holding device 50 is formed of a molded resin. The holding device 50 is integrally provided with an attaching portion 51 having elastic engaging pieces 53 on an inner surface of an insertion hole 52, and holding portions 55 and 57 disposed on both sides of the attaching portion 51 for holding an article. The holding portions 55 and 57 have concave shapes corresponding to bar-shaped members P1 and P2, and holding pieces 56 and 58 are formed on openings of the concave shapes. The attaching portion 51 includes the insertion hole 52 corresponding to a stud 60 with a circumferential groove 61; four elastic engaging pieces 53 oppositely formed on the inner surface of the insertion hole 52 at two levels; and wobble prevention pieces 54 oppositely formed on the inner surface of the insertion hole 52 for contacting an outer surface of the stud 60 to prevent wobble. A distance between the opposite engaging pieces 53 is smaller than an outer diameter of the stud 60. As shown in FIG. 13(b), end claw portions engage the circumferential groove 61. In the conventional holding device, the engaging pieces 53 obliquely protrude from the inner surface of the insertion hole 52 at right and left sides adjacent to the holding portions 55 and 57, and the wobble prevention pieces 54 protrude similarly.

The holding device 50 described above is used for holding the bar-shaped members along a panel 65. In an operation, after the bar-shaped members P1 and P2 are held in the holding portions 55 and 57 through the holding pieces 56 and 58, the attaching portion 51 is fixed to the stud 60 on the panel. Alternatively, the attaching portion 51 is fixed to the stud 60 in advance, and the bar-shaped members P1 and P2 are attached to the holding portions 55 and 57. In the fixing operation, after a center of the insertion hole 52 is aligned with the stud 60, the holding device 50 is strongly pushed against the panel 65. Accordingly, after the stud 60 abuts against the engaging pieces 53 in the insertion hole 52, the stud 60 passes through a space between the engaging pieces 53 at a lower level to a space between the engaging pieces 53 at an upper level while elastically expanding the engaging pieces 53. When the attaching portion 51 contacts the panel 65, the end claws of the engaging pieces 53 engage the circumferential groove 61 of the stud 60. The holding device 50 is fixed with a force proportion to an engagement between the engaging pieces 53 and the stud 60.

Patent Reference 1: Japanese Patent Publication (Kokai) No. 2000-28042

In the holding device 50, it is necessary to have sufficient engagement strength relative to the stud 60. Further, it is necessary to reduce a distance L between the holding portions 55 and 57, or a distance L1 or L2 from the attaching portion 51 (the stud 60) to the holding portion 55 or 57 to make the holding device 50 small. However, the conventional engaging pieces 53 protrude toward to the axis of the insertion hole from the inner surface of the insertion hole 52 at right and left sides adjacent to the holding portions 55 and 57. The wobble prevention pieces 54 protrude in a similar fashion, and this configuration is considered to be necessary for removing a molded part from a molding die. Also, it is necessary to provide a space for the engaging piece 53 to elastically deform. Accordingly, in the conventional holding device, it is difficult to reduce the distances L, L1, and L2, and to attach an article at a position close to the stud.

In view of the problems described above, an object of the present invention is to provide a holding device with a simple structure. As compared with the conventional device, it is possible to hold an article close to a stud, thereby improving design flexibility and expanding applications.

Further objects and advantages of the invention will be apparent from the following description of the invention.

### SUMMARY OF THE INVENTION

In order to attain the objects described above, according to the present invention, a holding device made of a resin is integrally provided with an attaching portion having a plurality of elastic engaging pieces on an inner surface of an insertion hole, and at least one holding portion disposed on one side or both sides of the attaching portion for holding an article. A stud with a circumferential groove protrudes from a panel. The stud is inserted into the insertion hole while the engaging pieces deform elastically, and the engaging pieces engage the circumferential groove of the stud, thereby fixing the holding device to the stud. The engaging pieces are oppositely formed on the internal surface of the insertion hole at front and rear sides shifted by 90 degrees from sides adjacent to the holding portion. Also, the engaging pieces are arranged at more than two levels in an axial direction of the insertion hole.

In the present invention, it is possible to dispose the holding portion close to the stud while maintaining a sufficient length of the elastic engaging pieces. In other words, in the present invention, the elastic engaging pieces are oppositely formed on the internal surface of the insertion hole at the front and rear sides shifted by 90 degrees from the sides (left and right sides) adjacent to the holding portion. Also, the engaging pieces are arranged at more than two levels in an axial direction of the insertion hole. The front and rear sides shifted by 90 degrees from the sides adjacent to the holding portion are situated along a direction crossing a longitudinal direction of the article held in the holding portion. In this configuration, the inner surface of the insertion hole is defined by the left and right sides adjacent to the holding portion and the front and rear sides where the elastic engaging pieces oppositely formed. A molding die is formed of left and right sliding dies and an insertion core.

According to a first aspect of the present invention, as compared with a conventional holding device, it is possible to reduce a distance between the holding portions, or a distance from the attaching portion to the holding portion without an influence of the engaging pieces. Accordingly, it is possible to reduce a distance between the left and right sides of the inner surface of the insertion hole adjacent to the holding portion down to the outer diameter of the stud. As a result, it is possible to dispose the holding portion close to the stud, thereby improving design flexibility and expanding applications. The elastic engaging pieces are arranged oppositely at more than two levels, and include more than four pieces, so that the engaging pieces strongly and stably engage the circumferential groove of the stud.

According to a second aspect of the present invention, the opposing engaging pieces may have base portions arranged at a substantially same level. Accordingly, it is possible to stably maintain the engagement relative to the stud and reduce an entire length of the device as compared with a structure in which the base portions are arranged at shifted positions.

According to a third aspect of the present invention, the holding portion may have a concave portion for holding a bar-shaped member, and the attaching portion is disposed adjacent to the concave portion. Accordingly, it is easy to hold the bar-shaped member along the panel.

According to fourth and fifth aspects of the present invention, the left and right sides of the internal surface of the insertion hole adjacent to the holding portion function as regulating portions for regulating a movement of the stud in a radial direction. Accordingly, it is possible to stably fix the holding device to the stud. When the regulating portions extend over a whole length of the insertion hole in a vertical direction, it is possible to fix the holding device to the stud more effectively.

### BRIEF DESCRIPTION OF THE DRAWINGS

FIG. 1 is a perspective view showing a holding device for a stud according to a first embodiment of the present invention;

FIGS. 2(a) to 2(d) are views showing the holding device viewed from different directions;

FIGS. 3(a) and 3(b) are enlarged sectional views showing an essential part of the holding device;

FIGS. 4(a) and 4(b) are schematic views showing a molding die of the holding device;

FIGS. 5(a) to 5(d) are views showing a holding device for a stud corresponding to FIGS. 2(a) to 2(d) according to a second embodiment of the present invention;

FIGS. 6(a) and 6(b) are enlarged sectional views showing the holding device shown in FIGS. 5(a) and 5(d) to correspond to FIGS. 3(a) and 3(b);

FIGS. 7(a) to 7(d) are views showing a holding device for a stud corresponding to FIGS. 2(a) to 2(d) according to a third embodiment of the present invention;

FIGS. 8(a) to 8(c) are enlarged sectional views showing an essential part of the holding device;

FIGS. 9(a) to 9(d) are views showing a holding device for a stud corresponding to FIGS. 2(a) to 2(d) according to a fourth embodiment of the present invention;

FIGS. 10(a) and 10(b) are enlarged sectional views showing the holding device shown in FIGS. 9(a) and 9(d) to correspond to FIGS. 3(a) and 3(b);

FIGS. 11(a) to 11(d) are views showing a holding device for a stud corresponding to FIGS. 2(a) to 2(d) according to a fourth embodiment of the present invention;

FIGS. 12(a) and 12(b) are enlarged sectional views showing the holding device shown in FIGS. 11(a) and 11(d) to correspond to FIGS. 3(a) and 3(b); and

FIGS. 13(a) and 13(b) are explanatory views showing a conventional holding device.

### DETAILED DESCRIPTION OF PREFERRED EMBODIMENTS

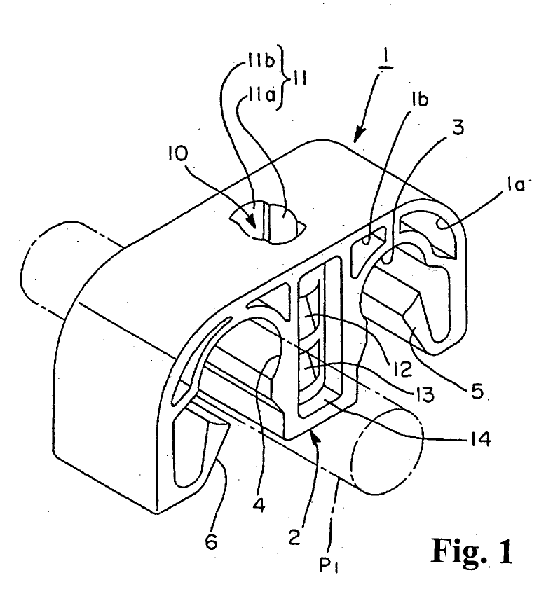

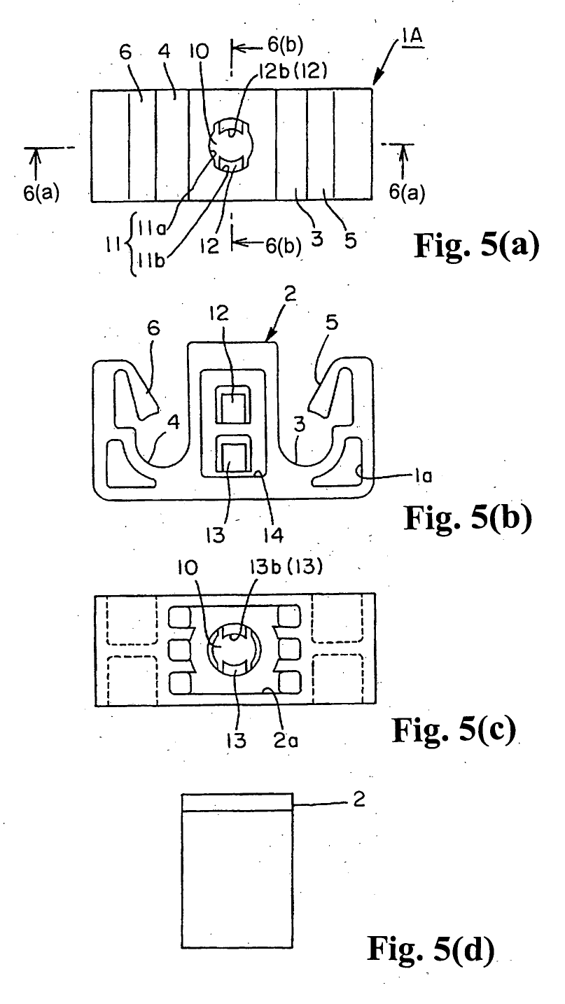

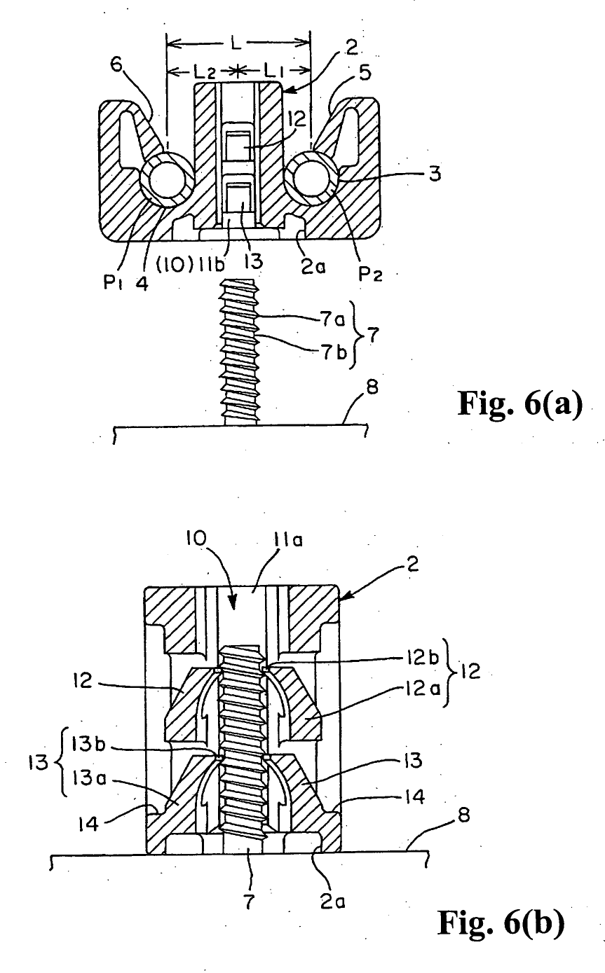

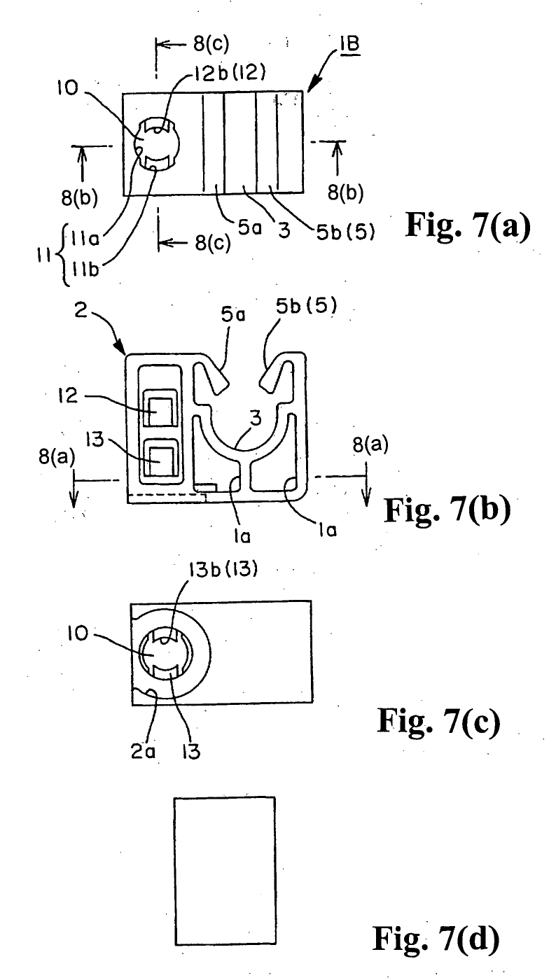

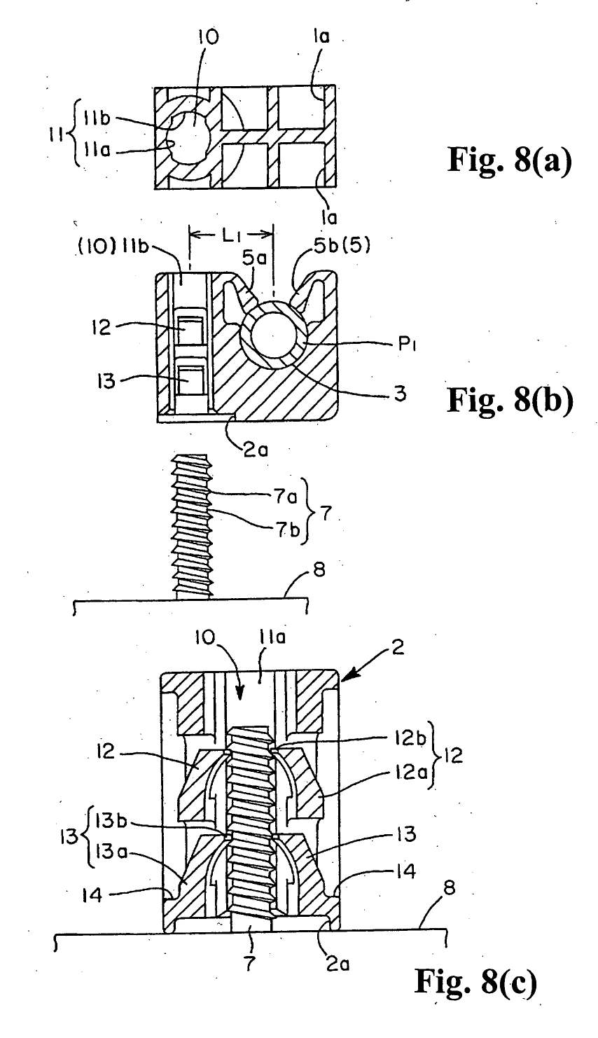

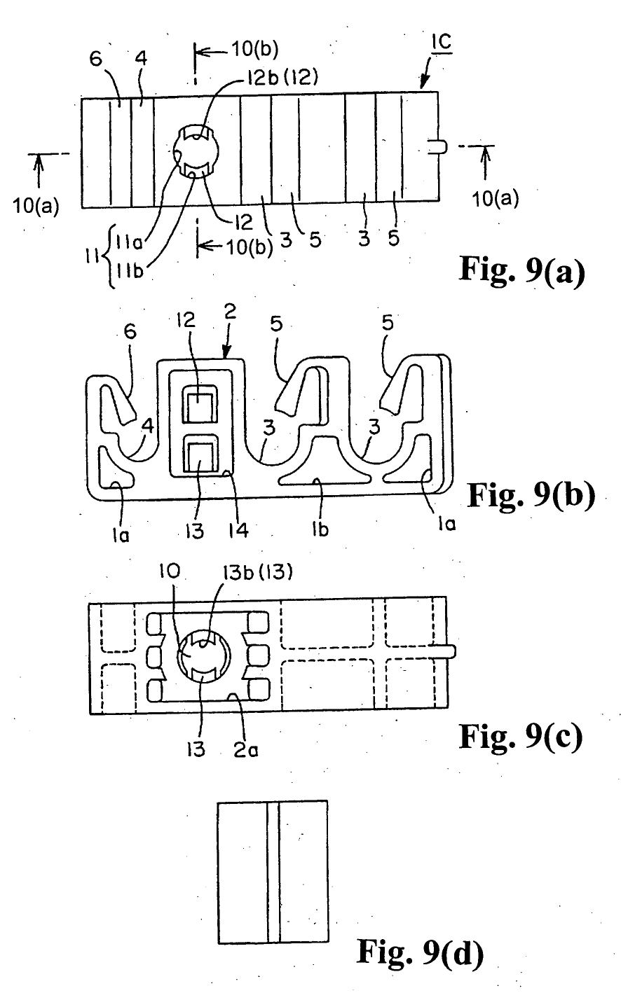

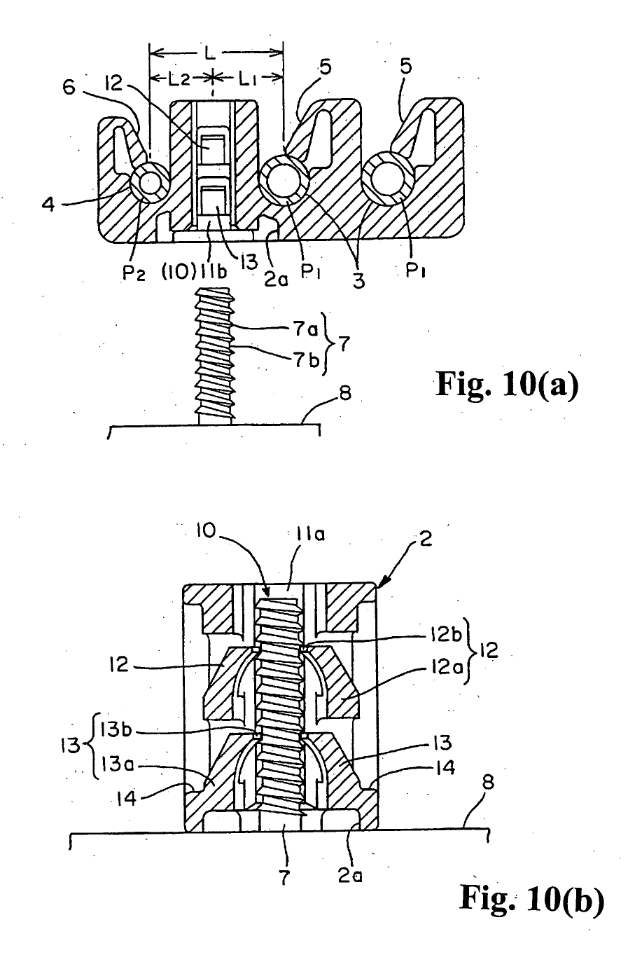

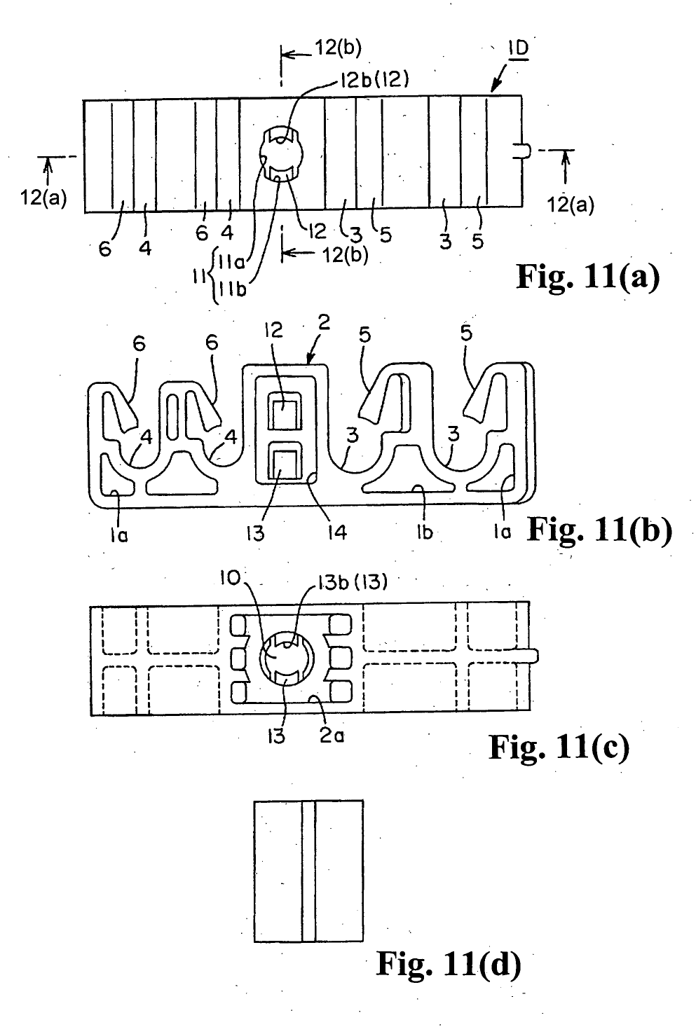

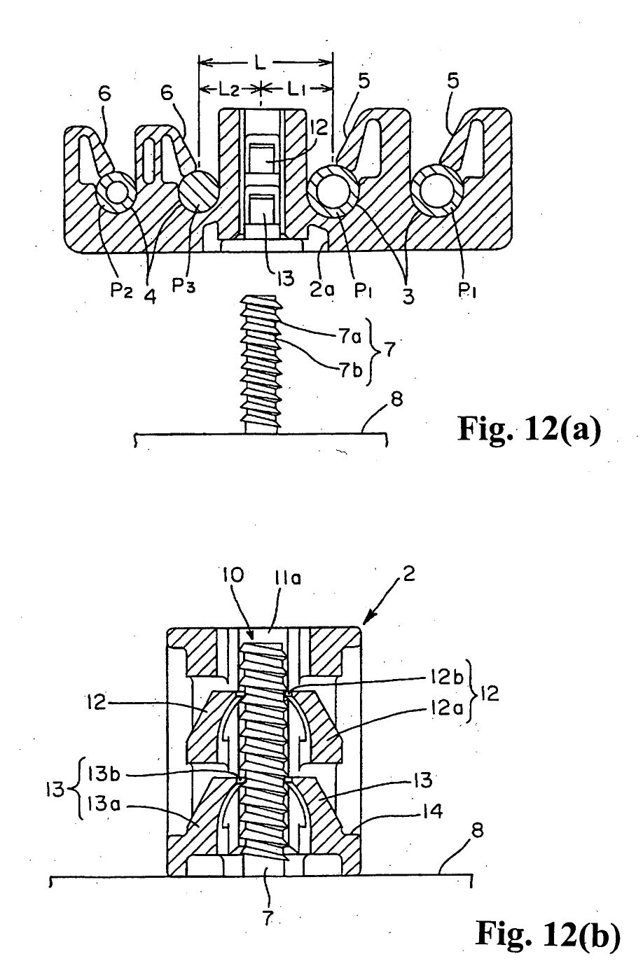

Hereunder, embodiments of the present invention will be explained with reference to the accompanying drawings. FIG. 1 to FIGS. 4(a) and 4(b) are views showing a first embodiment of the present invention. FIGS. 5(a)-5(d) to FIGS. 6(a) and 6(b) are views showing a second embodiment of the present invention. FIGS. 7(a)-7(d) to FIGS. 8(a)-8(c) are views showing a third embodiment of the present invention. FIGS. 9(a)-9(d) to FIGS. 10(a) and 10(b) are views showing a fourth embodiment of the present invention. FIGS. 11(a)-11(d) to FIGS. 12(a) and 12(b) are views showing a fifth embodiment of the present invention. In each embodiment, operationally same components are designated by the same reference numerals, and descriptions thereof are omitted. The following description will explain features of a resin holding device for a stud according to the first embodiment. Then, modified features of the second to fifth embodiments will be explained.

### First Embodiment

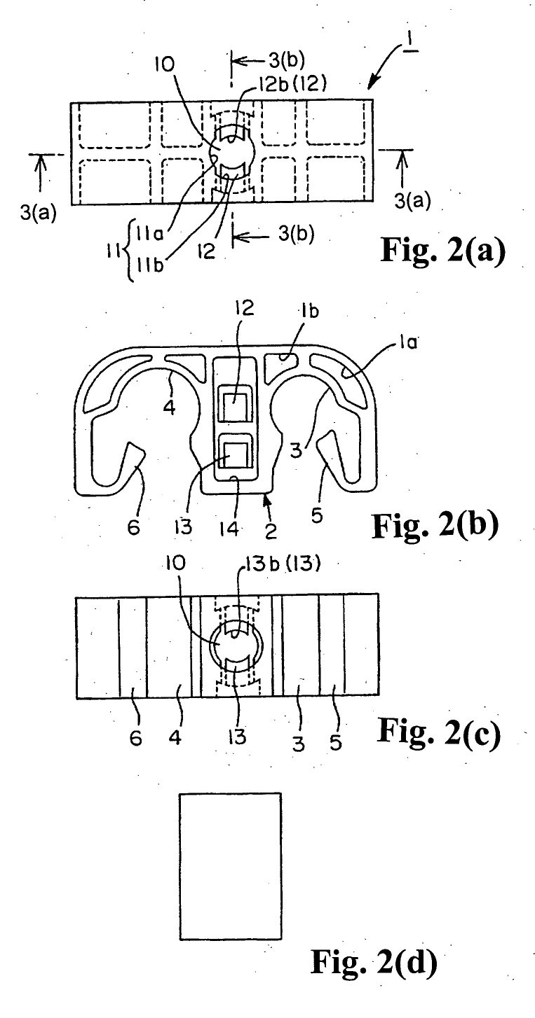

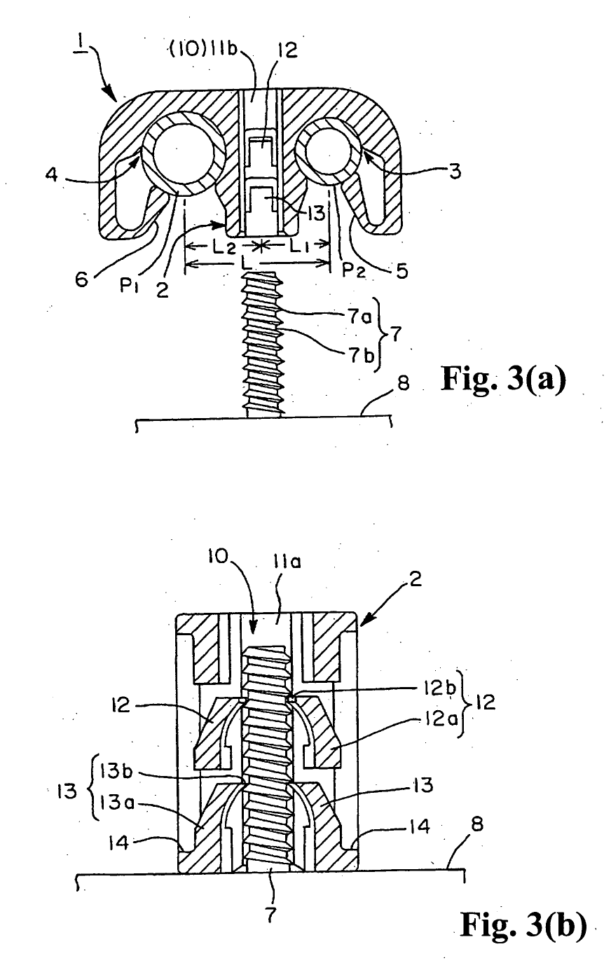

FIG. 1 is a view showing the resin holding device for a stud according to the invention. FIGS. 2(a) to 2(d) are views showing the holding device in detail, wherein FIG. 2(a) is a plan view thereof, FIG. 2(b) is a front view thereof, FIG. 2(c) is a bottom view thereof, and FIG. 2(d) is a side view thereof. FIGS. 3(a) and 3(b) are views showing the holding device in use, wherein FIG. 3(a) is a view showing a state right before fixing to a stud taken along line 3(a)-3(a) in FIG. 2(a), and FIG. 3(b) is an enlarged view showing a fixed state relative to the stud taken along line 3(b)-3(b) in FIG. 2(a). A holding device 1 is formed of a synthetic resin, and has an attaching portion 2 to be fixed to a stud 7 and holding portions 3 and 4 on both sides for holding bar-shaped members P1 and P2 as articles. The stud 7 includes a stud bolt with a male screw 7a, and has the continuous male screws 7a and circumferential groove (root of the male screw) 7b. The stud 7 is fixed to a panel 8 such as a car body with welding, and protrudes from a corresponding surface of the panel. The bar-shaped members P1 and P2 include pipes, rod members, or bundled wire rods or wire rods.

The holding portions 3 and 4 have a concave shape similar to the bar-shaped members P1 and P2, and have holding pieces 5 and 6 placed at an entrance side of the concave shape. In this embodiment, the bar-shaped member P1 is held and supported in the concave shape of the holding portion 4 while the holding piece 6 elastically deforms inwardly. The holding structure may be modified in many ways as described later. Reference numerals 1a and 1b denote hollow portions.

The attaching portion 2 has an insertion hole 10 and a plurality of elastic engaging pieces 12 and 13 protruding from an internal surface 11 of the insertion hole 10. The insertion hole 10 is situated at a center of the attaching portion 2, and passes through in an upper-to-lower direction or a vertical direction. The internal surface 11 defining the insertion hole 10 has different inner diameters at left and right surface portions 11a (opposite sides) adjacent to the holding portions 3 and 4 and front and rear surface portions 11b (opposite sides) shifted by 90 degrees from the left and right surface portions 11a. The front and rear surface portions 11b are arranged crossing a longitudinal direction of the bar-shaped members P1 and P2 held by the holding portions 3 and 4. A distance (inner diameter) between left and right surfaces constituting the left and right surface portions 11a is substantially equal to an outer diameter (male screw 7a) of the stud 7. Accordingly, when the stud 7 is inserted into the insertion hole 10, the left and right surfaces 11a function as regulating portions for regulating a movement of the stud 7 in a radial direction.

On the other hand, a distance (inner diameter) between front and rear surfaces constituting the front and rear surface portions 11b is larger than the distance (inner diameter) between the left and right side surfaces constituting the left and right surface portions 11a. The engaging pieces 12 at an upper level and engaging pieces 13 at a lower level are formed on the front and rear surface portions 11b. The engaging pieces 12 and 13 oppositely protrude from the front and rear surfaces constituting the front and rear surface portions 11b, and include total four pieces at the upper and lower levels. That is, the attaching portion 2 has recess portions 14 with a rectangular shape at the front and back side surfaces thereof. The engaging pieces 12 and 13 are disposed in the recess portions 14 with rectangular slits in between. Base portions 12a and 13a are connected to the front and rear surface portions 11b, and end claws 12b and 13b protrude toward an axis of the insertion hole 10. The opposite engaging pieces 12 and 13 are able to rotate around the base portions 12a and 13a for receiving the stud 7 while rotating and for elastically engaging the end claws 12b and 13b with the circumferential groove 7b. Each of the base portions 12a and 13a of the opposite engaging pieces 12 and 13 is placed on a same level position and has a same shape. The opposite engaging pieces 12 and 13 have a substantially same shape, and may have different widths and lengths as far as there is no effect on a molding method described next.

(Molding Method)

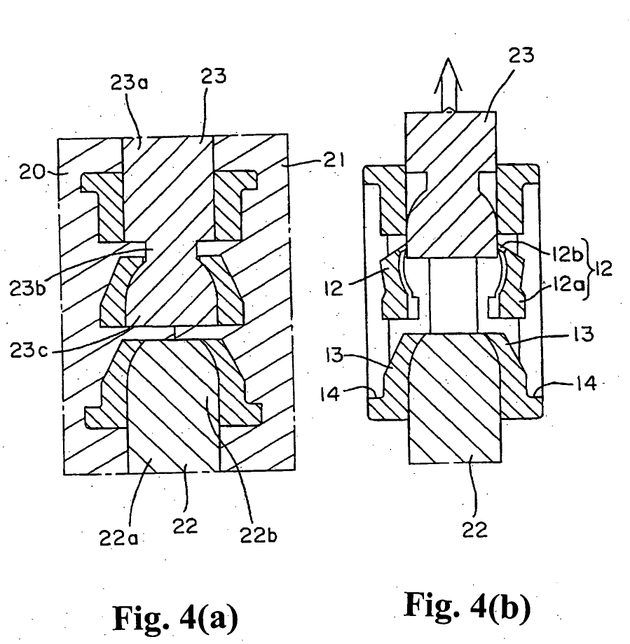

The holding device 1 is molded from a synthetic resin with injection molding method similar to a conventional method, and a molding die is different from that in the conventional molding method as explained below. That is, as shown in FIG. 4(a), the molding die includes left and right slide dies 20 and 21 capable of sliding in a lateral direction as a main unit, a core 22 for forming the opposite engaging pieces 13 at a lower hole portion or the lower level of the insertion hole 10, and a core 23 for forming the opposite engaging piece 12 at an upper hole portion or the upper level of the insertion hole 10. Among the cores 22 and 23, the core 22 has a part 22a for forming a hole portion below the engaging pieces 13, and a part 22b for forming inner hole portions of the engaging pieces 13. The core 23 has a part 23a for forming a hole portion above the engaging pieces 12, a part 23c for forming inner hole portions of the engaging pieces 12, and a small diameter part 23b connecting between the part 23a and the part 23c. In the molding method, after a resin material is injected into a cavity formed with the slide dies 20 and 21 and the cores 22 and 23, the molding die is cooled to a specific temperature and a molded part is removed from the molding die. In the step of removal, after the slide dies 20 and 21 slide out, when the core 23 moves in an arrow direction in FIG. 4(b), the molded part is removed while the engaging pieces 12 forcibly rotate outwardly. The engaging pieces 12 return to a regular state when the core 23 is pulled out. The core 22 may be pulled out before or after the core 23 is pulled out.

(Operation)

An operation of installing and using the holding device 1 will be explained next. The stud 7 is connected to a panel 8 such as a car body with welding. In the operation of installing, after the bar-shaped members P1 and P2 are attached to the holding portions 3 and 4, the holding device is fixed to the stud 7. In the operation, as shown in FIG. 3(a), the holding device 1 is pushed toward the panel 8 in a state that the insertion hole 10 of the attaching portion 2 is aligned with the stud 7. The stud 7 passes through a space between the engaging pieces 12 at the upper level from a space between the engaging pieces 13 at the lower level while expanding the engaging pieces 12 and 13 protruding from the front and rear surface portions 11b in the insertion hole 10. The end claws 13b and 12b of the engaging pieces 13 and 12 engage the stud circumferential groove 7b (root or flank of the male screw) when a lower end surface of the attaching portion 2 abuts against the panel 8.

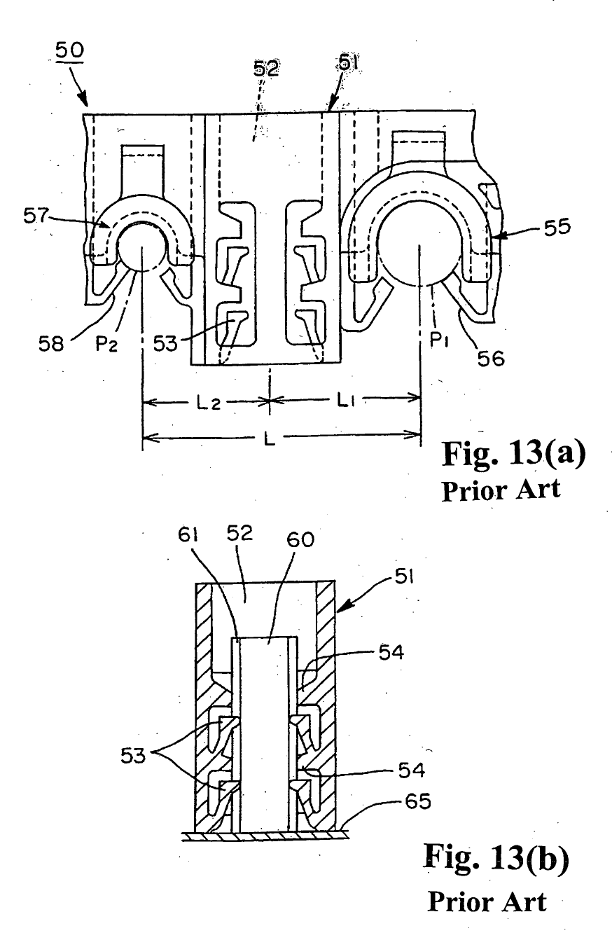

In this configuration, the holding device 1 is fixed to the stud 7 through the engagement of the engaging pieces 12 and 13 protruding from the side of front and rear surface portions 11b. Further, the left and right side surfaces 11a have the regulating function, that is, the left and right side surfaces 11a contact an outer surface of the stud to regulate a position thereof. Accordingly, it is possible to stably maintain the fixed state. In this configuration, as shown in FIG. 3(a) and FIG. 13(a), it is possible to reduce a distance L between the holding portions 3 and 4, and a distance L1 or L2 between the attaching portion 2 (the stud 7) and the holding portions 12 and 13 without an influence of a length of the engaging pieces 12 and 13. Accordingly, in the holding device 1, it is possible to reduce the distance between the left and right surfaces 11a of the internal surface 11 of the insertion hole 10 adjacent to the holding portions 3 and 4 to the outer diameter of the stud 7, thereby making it possible to dispose the holding portions 3 and 4 close to the stud 7.

### Second Embodiment

FIGS. 5(a) and 5(d) are views showing a holding device for a stud corresponding to FIGS. 2(a) to 2(d), wherein FIG. 5(a) is a plan view thereof, FIG. 5(b) is a front elevation thereof, FIG. 5(c) is a bottom view thereof, and FIG. 5(d) is a side view thereof. FIGS. 6(a) and 6(b) are views showing the holding device in use corresponding to FIGS. 3(a) and 3(b), wherein FIG. 6(a) is a view showing a state right before fixing to a stud taken along line 6(a)-6(a) in FIG. 5(a), and FIG. 6(b) is an enlarged view showing a fixed state relative to the stud taken along line 6(b)-6(b) in FIG. 5(a). A holding device 1A of the second embodiment is fixed to the panel 8 upside down relative to the holding device 1 of the first embodiment. That is, the holding device 1A is fixed to the panel 8 with the openings of the holding portions 3 and 4 facing upwardly. Reference numeral 2a is a space formed in a lower surface of the holding device 1A contacting the panel 8 around the insertion hole 10. When the stud 7 has a projecting part (head of the stud bolt, etc.), the step 2a accommodates the projecting part. In an operation of using the holding device 1A, after the bar-shaped members P1 and P2 are attached to the holding portions 3 and 4 through the holding pieces 5 and 6, the attaching portion 2 is fixed to the stud 7. Alternatively, after the attaching portion 2 is fixed to the stud 7 in advance, the bar-shaped members P1 and P2 are attached to the holding portions 3 and 4.

### Third Embodiment

FIGS. 7(a) and 7(d) are views showing a holding device for a stud corresponding to FIGS. 2(a) to 2(d), wherein FIG. 7(a) is a plan view thereof, FIG. 7(b) is a front elevation thereof, FIG. 7(c) is a bottom view thereof, and FIG. 7(d) is a side view thereof. FIGS. 8(a) to 8(c) are views showing the holding device in use corresponding to FIGS. 3(a) and 3(b), wherein FIG. 8(a) is a sectional view taken along line 8(a)-8(a) in FIG. 7(b), FIG. 8(b) is a view showing a state right before fixing to a stud taken along line 8(b)-8(b) in FIG. 7(a), and FIG. 8(c) is an enlarged view showing a fixed state relative to the stud taken along line 8(c)-8(c) in FIG. 7(a). A holding device 1B of the third embodiment is an example that the holding portion is provided on only one side of the attaching portions as compared with the first and second embodiments. Also, in the holding device 1B, the holding portion 3 has opposite holding pieces 5a and 5b (5) for holding the bar-shaped member P1 not to come off. In an operation of using the holding device 1B, similar to the second embodiment, after the bar-shaped member P1 is attached to the holding portion 3 through the holding piece 5, the attaching portion 2 is fixed to the stud 7. Alternatively, after the attaching portion 2 is fixed to the stud 7 in advance, the bar-shaped member P1 is attached to the holding portion 3.

### Forth Embodiment

FIGS. 9(a) and 9(d) are views showing a holding device for a stud corresponding to FIGS. 2(a) to 2(d), wherein FIG. 9(a) is a plan view thereof, FIG. 9(b) is a front elevation thereof, FIG. 9(c) is a bottom view thereof, and FIG. 9(d) is a side view thereof. FIGS. 10(a) and 10(b) are views showing the holding device in use corresponding to FIGS. 3(a) and 3(b), wherein FIG. 10(a) is a view showing a state right before fixing to a stud taken along line 10(a)-10(a) in FIG. 9(a), and FIG. 10(b) is an enlarged view showing a fixed state relative to the stud taken along line 10(b)-10(b) in FIG. 9(a). A holding device 1C of the forth embodiment is an example having three holding portions as compared with the first to third embodiments. In the other words, in the holding device 1C, two holding portions 3 are provided on one side of the attaching portion 2, and one holding portion 4 is provided on the other side of the attaching portion 2. Each of the holding portions 3 has the holding piece 5, and holds the bar-shaped member P1 in the concave portion with the holding piece 5. The holding portion 4 has a holding piece 6, and holds the bar-shaped member P2 in the concave portion with the holding piece 6. In an operation of using the holding device 1C, similar to the second embodiment, after the bar-shaped members P1 and P2 are attached to the holding portions 3 and 4 through the holding pieces 5 and 6, the attaching portion 2 is fixed to the stud 7. Alternatively, after the attaching portion 2 is fixed to the stud 7 in advance, the bar-shaped members P1 and P2 are attached to the holding portions 3 and 4.

### Fifth Embodiment

FIGS. 11(a) and 11(d) are views showing a holding device for a stud corresponding to FIGS. 2(a) to 2(d), wherein FIG. 11(a) is a plan view thereof, FIG. 11(b) is a front elevation thereof, FIG. 11(c) is a bottom view thereof, and FIG. 11(d) is a side view thereof. FIGS. 12(a) and 12(b) are views showing the holding device in use corresponding to FIGS. 3(a) and 3(b), wherein FIG. 12(a) is a view showing a state right before fixing to a stud taken along line 12(a)-12(a) in FIG. 11(a), and FIG. 12(b) is an enlarged view showing a fixed state relative to the stud taken along line 12(b)-12(b) in FIG. 11(a). A holding device 1D of the fifth embodiment is an example having four holding portions as compared with the first to fourth embodiments. In the other words, in the holding device iD, two holding portions 3 and 3 are provided on one side of the attaching portion 2, and two holding portions 4 are provided on the other side of the attaching portion 2. Each of the holding portions 3 has the holding piece 5, and the bar-shaped member P1 is held in the concave portion with the holding piece 5. Each of the holding portions 4 has the holding piece 6, and the bar-shaped members P2 and P3 are held in the concave portions with each of the holding pieces 6. In an operation of using the holding device 1D, similar to the second embodiment, after the bar-shaped members P1, P2, and P3 are attached to the holding portions 3 and 4 through the holding pieces 5 and 6, the attaching portion 2 is fixed to the stud 7. Alternatively, after the attaching portion 2 is fixed to the stud 7 in advance, the bar-shaped members P1, P2, and P3 are attached to the holding portions 3 and 4.

The invention is not limited to the embodiments described above. The holding device of the present invention includes the features described above, and it is possible to modify a structure of the holding portion if needed. Also, the elastic engaging pieces may be provided at more than two levels such as three or four levels.

The disclosure of Japanese Patent Application No. 2004-152946, filed on May 24, 2004, is incorporated in the application.

While the invention has been explained with reference to the specific embodiments of the invention, the explanation is illustrative and the invention is limited only by the appended claims.

1. A holding device to be fixed to a stud with a circumferential groove, comprising:
at least one holding portion for holding an article, and
an attaching portion integrally formed at one side of the at least one holding portion, and having an insertion hole for receiving the stud therein and a plurality of elastic engaging pieces on an inner surface of the insertion hole, said engaging pieces being formed at front and rear sides opposite to each other of the inner surface shifted by 90 degrees from the one side of the holding portion.

2. A holding device according to claim 1, wherein said engaging pieces are arranged at more than two levels in an axial direction of the insertion hole.

3. A holding device according to claim 1, wherein said engaging pieces facing each other include base portions arranged at a substantially same level.

4. A holding device according to claim 1, wherein said holding portion includes a concave portion for holding a bar-shaped member as the article, said attaching portion being disposed at one side of the concave portion.

5. A holding device according to claim 1, further comprising regulating portions formed on sides of the inner surface of the insertion hole shifted by 90 degrees from the engaging pieces for regulating movement of the stud in a radial direction.

6. A holding device according to claim 5, wherein said regulating portions extend over a whole length of the insertion hole in a vertical direction.

7. A holding device according to claim 1, wherein said attaching portion is situated between two holding portions.
